(19) United States
(12) Patent Application Publication
(10) Pub. No.: US 2024/0183802 A1
(43) Pub. Date: Jun. 6, 2024

(54) MOBILE X-RAY RADIATION IMAGING SYSTEM AND RELATED METHOD

(71) Applicant: JST Power Equipment, Inc., Lake Mary, FL (US)

(72) Inventor: Haoning Liang, Beijing (CN)

(21) Appl. No.: 18/552,987

(22) PCT Filed: Apr. 6, 2022
(86) PCT No.: PCT/US2022/071567

§ 371 Date: Sep. 28, 2023

Related U.S. Application Data
(63) Continuation-in-part of application No. 17/314,003, filed on May 6, 2021, now abandoned.

(30) Foreign Application Priority Data
Apr. 7, 2021 (WO) PCT/CN2021/085791
Apr. 7, 2021 (WO) PCT/CN2021/085792

(51) Int. Cl. G01N 23/18; G01N 23/04; G01N 23/083

(52) U.S. Cl. CPC G01N 23/18; G01N 23/04; G01N 23/083; G01N 2223/501

(57) ABSTRACT

An X-ray radiation imaging system is for imaging an object. The X-ray radiation imaging system may include an X-ray source device configured to irradiate the object with X-ray radiation, an X-ray detector to be positioned adjacent the object and having a carrier layer, and X-ray sensing segments carried by the carrier layer and defining a sensing array. The X-ray sensing segments may receive the X-ray radiation through the object. The X-ray radiation imaging system may include an image extraction device configured to generate an image of the object based upon the X-ray detector.

### RELATED APPLICATION

This application claims priority to U.S. application Ser. No. 17/314,003 filed May 6, 2021, which claims priority to PCT application serial nos. PCT/CN2021/085791, PCT/CN2021/085792, both filed Apr. 7, 2021, which are all hereby incorporated herein in their entirety by reference.

### TECHNICAL FIELD

The present disclosure relates to the field of power transmission, and, more particularly, to power transformers and related methods.

### BACKGROUND

The modern power transmission system is a network connecting power plants to geographically remote large and small loads. Generally, the power transmission system comprises a power plant generating the power to be distributed, and a network of high voltage power transmission lines transmitting the power from the power plant to the remote geographic area where the loads exist. Once in the area, the power transmission system comprises a plurality of substations for respective regions. Each substation comprises step down transformers and switchgear equipment to route and convert the high voltage power signal (i.e. >115,000 VAC) to a medium voltage power signal (i.e. 2,400-69,000 VAC).

From that point, the power transmission system comprises medium voltage power transmission lines and low voltage power transmission lines, which transmit the power to the smaller loads. Of course, there are additional step-down transformers for the low voltage loads (i.e. 240-600 VAC), which include all residential and typical commercial applications. Since it is much more efficient to transmit power at high and medium voltages, the power transmission system necessarily comprises a large number of transformers located close to the smaller loads.

A typical transformer, regardless of voltage level, comprises a magnetic core, and sets of electrically conductive windings surrounding the magnetic core. The electrically conductive windings need to be electrically insulated from adjacent windings. Also, due to the operational power level of the transformers in the power transmission system, there is a desire to thermally cool the transformers. In one application, the windings and the magnetic core are immersed in dielectric oil (e.g. mineral oil). Although the thermal conductivity performance of these immersed transformers is good, when these transformers fail, the event may be problematic, due to the flammable nature of the dielectric oil. Moreover, in substations, there may be several adjacent components, which can be damaged.

To prevent these failures, dielectric oil transformers must be serviced and replaced on a recommended schedule. Another alternative approach is the cast resin transformer. In this approach, rather than dielectric oil, the electrically conductive windings are encased in a dielectric resin. Although the dielectric resin does not need to be serviced, the resin does provide less thermal dissipation than oil immersed transformers. Moreover, the cast resin transformer is not easily repairable.

### SUMMARY

Generally, an X-ray radiation imaging system is for imaging an object. The X-ray radiation imaging system may include an X-ray source device configured to irradiate the object with X-ray radiation, an X-ray detector to be positioned adjacent the object and comprising at least one carrier layer, and a plurality of X-ray sensing segments carried by the at least one carrier layer and defining a sensing array. The plurality of X-ray sensing segments may receive the X-ray radiation through the object. The X-ray radiation imaging system may include an image extraction device configured to generate an image of the object based upon the X-ray detector.

In some embodiments, the sensing array may comprise a rectangle-shaped array. Each X-ray sensing segment may comprise an X-ray phosphor plate. Each X-ray sensing segment in the sensing array may comprise an identifier opaque to the X-ray radiation through the object, and the image extraction device may be configured to generate the image of the object based upon a known position of respective identifiers in the sensing array.

The X-ray detector may comprise an arm coupled to the at least one carrier layer, and the arm may extend transverse to the at least one carrier layer and to engage the object. For example, the arm may comprise a clamp device.

In other embodiments, the at least one carrier layer may comprise a plurality of carrier layers, and a plurality of fasteners coupling the plurality of carrier layers together. The plurality of carrier layers may be arranged in a three-dimensional shape.

Moreover, the X-ray source device may comprise an X-ray source, and a platform carrying the X-ray source. The platform may be configured to position the X-ray source to irradiate the object based upon the sensing array.

Another aspect is directed to a method for X-ray radiation imaging of a cast resin transformer. The method may include positioning an X-ray detector within the cast resin transformer. The X-ray detector may comprise at least one carrier layer, and a plurality of X-ray sensing segments carried by the at least one carrier layer and defining a sensing array. The method may include positioning an X-ray source device to irradiate the cast resin transformer with X-ray radiation. The plurality of X-ray sensing segments may receive the X-ray radiation through the cast resin transformer. The method may further include generating an image of the cast resin transformer based upon the plurality of X-ray sensing segments.

Yet another aspect is directed to a method for detecting a defect in a cast resin transformer. The method may include irradiating the cast resin transformer with X-ray radiation from an X-ray source device. The cast resin transformer may include a plurality of coils. The method may comprise scanning the cast resin transformer with an X-ray detector comprising at least one carrier layer, and a plurality of X-ray sensing segments carried by the at least one carrier layer and defining a sensing array, the plurality of X-ray sensing segments to receive the X-ray radiation through the cast resin transformer. The method may include generating an image of the cast resin transformer based upon the X-ray radiation through the cast resin transformer and using separate individual images from each X-ray sensing segment. The method may comprise generating a metric for spacing between the plurality of coils based upon the image, and determining whether the cast resin transformer has a defect based upon the metric for spacing between the plurality of coils.

Also, the generating of the metric may comprise generating a plurality of spacing values for the plurality of coils of the cast resin transformer, and determining a distribution of the plurality of spacing values. The generating of the plurality of spacing values for the plurality of coils of the cast resin transformer may comprise edge detection processing.

### BRIEF DESCRIPTION OF THE DRAWINGS

FIG. 1 is a schematic diagram of a first example embodiment of an X-ray radiation imaging system, according to the present disclosure.

FIG. 2 is a schematic diagram of an X-ray sensing element from the X-ray radiation imaging system of FIG. 1.

FIG. 3 is a flowchart illustrating a method of operating the X-ray radiation imaging system of FIG. 1.

FIG. 4 is a schematic diagram of a second example embodiment of the X-ray detector from the X-ray radiation imaging system of FIG. 1.

FIG. 5 is a schematic diagram of a third example embodiment of the X-ray detector from the X-ray radiation imaging system of FIG. 1.

FIG. 6 is a schematic diagram of a fourth example embodiment of the X-ray detector from the X-ray radiation imaging system of FIG. 1.

FIG. 7 is a schematic diagram of a fifth example embodiment of the X-ray detector from the X-ray radiation imaging system of FIG. 1.

FIG. 8 is a schematic diagram of a sixth example embodiment of the X-ray radiation imaging system of FIG. 1.

FIG. 9 is a flowchart illustrating a method of detecting defects in a cast resin transformer using an example embodiment of the X-ray radiation imaging system of FIG. 1.

FIG. 10 is a schematic diagram of a seventh example embodiment of an X-ray radiation imaging system, according to the present disclosure.

### DETAILED DESCRIPTION

The present disclosure will now be described more fully hereinafter with reference to the accompanying drawings, in which several embodiments of the invention are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout, and base 100 reference numerals are used to indicate similar elements in alternative embodiments.

It may be helpful to evaluate cast resin transformers in the field. In particular, cast resin transformers may be subject to damage during use (e.g. due to improper voltage, or structure fatigue), and it may be helpful to evaluate cast resin transformers on a regular basis to determine whether replacement is needed. Moreover, if the cast resin transformer has a manufacturing defect, this may be discovered before failure occurs in the field. Given their upstream placement in the power transmission system, it is desirable to reduce the risk of failure.

X-ray detectors have wide usage in several fields. For example, X-ray imaging is ubiquitous in the medical imaging field. In some industrial applications, X-ray imaging, i.e. radiography, is used to verify the mechanical integrity and fidelity of components. Nevertheless, the use of X-ray imaging for cast resin is impractical for at least a couple of reasons. First, outdoor mobile X-ray imaging is difficult. X-ray sensing equipment is generally sensitive to environmental conditions. Moreover, it may be impossible to scan a cast resin transformer while installed. Indeed, the tubular structure is generally filled with additional electronics on the inside. Lastly, typical X-ray imaging would cause potential damage to the cast resin transformer during removal and reinstallation.

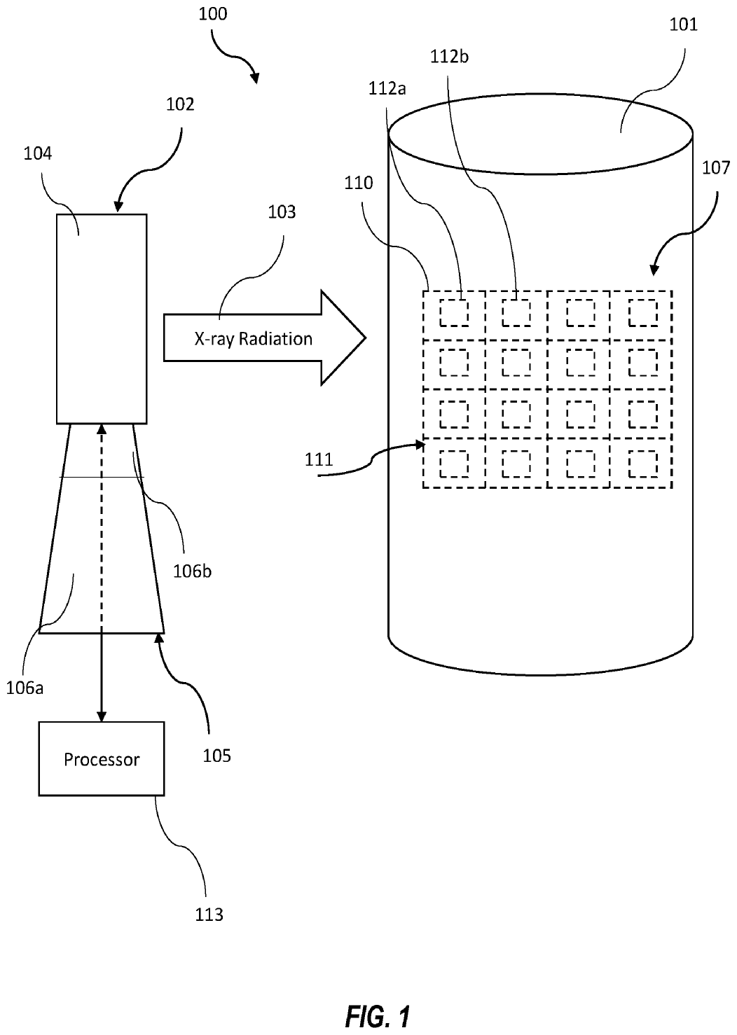

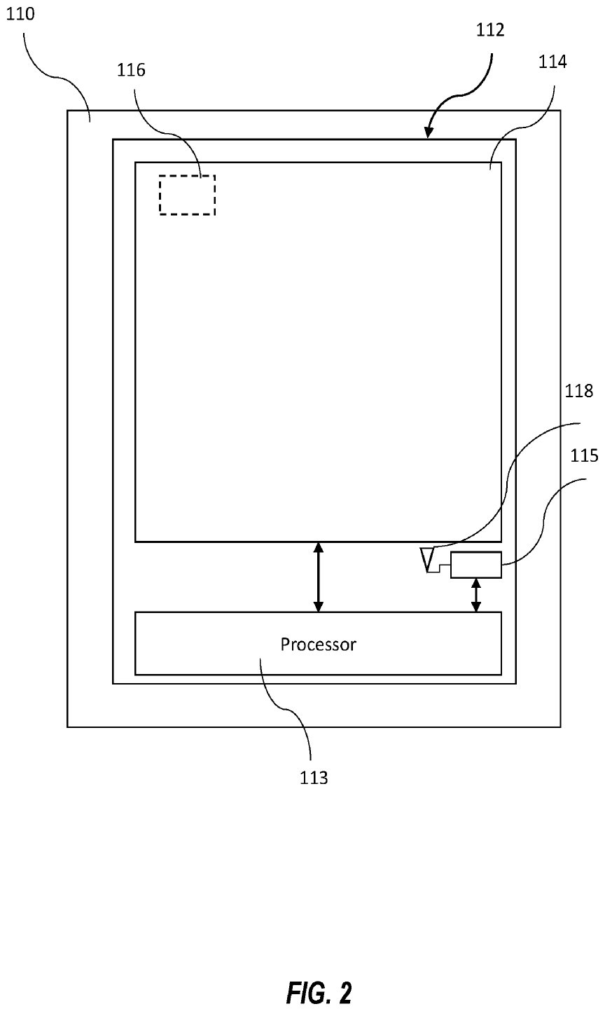

Referring now to FIGS. 1-2, an X-ray radiation imaging system 100 according to the present disclosure is now described. The X-ray radiation imaging system 100 is for imaging an object 101. For example, the object 101 may comprise a tubular structure, such as a cast resin transformer. The X-ray radiation imaging system 100 illustratively includes an X-ray source device 102 configured to irradiate the object with X-ray radiation 103. Moreover, the X-ray source device 102 illustratively includes an X-ray source 104, and a platform 105 carrying the X-ray source. The platform 105 is configured to position the X-ray source to irradiate the object 101. In particular, the platform 105 comprises multi-leg base 106a for placement on a ground surface/floor, and a telescoping upper end 106b for vertically positioning the X-ray source 104. The telescoping upper end 106b may comprise a pair of sliding concentric tubes permitting longitudinal extension and retraction thereof, and a locking device (e.g. transverse push pin or screw) for locking a longitudinal position. Also, the telescoping upper end 106b is configured to permit rotational positioning to properly irradiate the object 101.

The X-ray radiation imaging system 100 illustratively includes an X-ray detector 107 to be positioned adjacent the object 101. In particular, for applications where the object 101 comprises a cast resin transformer, the X-ray detector 107 is inserted into an interior of the transformer.

Although the illustrated embodiment operates with X-ray radiation, other frequencies/types of radiation may be used. For example, the radiation may comprise gamma radiation, neutron radiation, beta particle radiation, proton particle radiation, and alpha particle radiation.

The X-ray detector 107 illustratively includes a carrier layer 110. In some embodiments, the carrier layer 110 may comprise a flexible carrier layer (i.e. able to take on curved shapes), but in other embodiments, the carrier layer 110 may comprise a rigid carrier layer. The X-ray detector 107 illustratively includes a plurality of X-ray sensing segments 112a-112n carried by the carrier layer 110 and defining a sensing array 111. Helpfully, the flexible nature of the X-ray detector 107 permits it to be readily inserted into the object 101, for example, the cast resin transformer.

The plurality of X-ray sensing segments 112a-112n may be coupled to the carrier layer 110 via any suitable mechanical method. In some embodiments, each X-ray sensing segments 112a-112n comprises an adhesive layer for coupling to the carrier layer 110. In other embodiments, the carrier layer 110 comprises a plurality of pockets/recesses (e.g. closable pockets) for respectively receiving the plurality of X-ray sensing segments 112a-112n. In yet other embodiments, a hook and loop interface between the carrier layer 110 and the plurality of X-ray sensing segments 112a-112n may be used. In some embodiments, the carrier layer 110 comprises a plurality of openings defining the sensing array 111, and each X-ray sensing segment 112a-112n has an arm to be inserted within a respective opening.

The platform 105 is configured to position the X-ray source 104 to irradiate the object 101 based upon the sensing array 111. In particular, the X-ray radiation 103 is desirably substantially (i.e. each X-ray sensing segments 112a-112n receiving an amount of radiation being ±5% within a mean radiation value) evenly distributed across the sensing array 111.

In the illustrated embodiments, the sensing array 111 comprises a rectangle-shaped array, for example, the 4×4 array shown in FIG. 1. It should be appreciated that this is an exemplary size, and other array shapes and sizes are possible. Indeed, in some embodiments, a single column array may be used, such as a 1×8 array. These single column embodiments would be advantageous for difficult imaging applications where there is little room for insertion of the X-ray detector 107.

The plurality of X-ray sensing segments 112a-112n are to receive the X-ray radiation 103 from the object 101. As will be appreciated, the object 101 will scatter the X-ray radiation 103, which will be received by the X-ray detector 107. The X-ray radiation imaging system 100 illustratively comprises an image extraction device (e.g. the illustrated processor) 113 coupled to the X-ray source device 102 and the X-ray detector 107 and configured to generate an image of the object 101. In some embodiments, the telescoping upper end 106b comprises one or more electric motors for actuating longitudinal extension and rotational movement thereof, and the image extraction device 113 is configured to cause the one or more electric motors to position the X-ray source 104 to irradiate the object 101 automatically and without user intervention.

As perhaps best seen in FIG. 2, each X-ray sensing segment 112a-112n illustratively comprises an X-ray phosphor plate 114 configured to generate an image of the X-ray radiation 103 received by the phosphor plate. Also, each X-ray sensing segment 112a-112n includes a wireless transceiver 115 and associated antenna 118 coupled to the X-ray phosphor plate 114 and configured to transmit to the image of the X-ray radiation 103 received by the phosphor plate to the image extraction device 113. In other embodiments, each X-ray sensing segment 112a-112n includes a wired transceiver, and associated wiring for coupling to the image extraction device 113.

Each X-ray sensing segment 112a-112n in the sensing array 111 illustratively comprises an identifier 116 opaque to the X-ray radiation 103 from the object 101. In some embodiments, the identifier 116 is a marker (e.g. identification string, geometric pattern of holes) visible in image of the X-ray radiation 103. The image extraction device 113 is configured to generate the image of the object 101 based upon a known position of respective identifiers in the sensing array 111. In other words, the image extraction device 113 is configured to assemble or stitch together the image of the X-ray radiation 103 received by the phosphor plates 114 into an assembled image of the object 101. In applications where the object 101 comprises a cast resin transformer comprising a plurality of coils, the assembled image depicts the spacing and position of the plurality of coils.

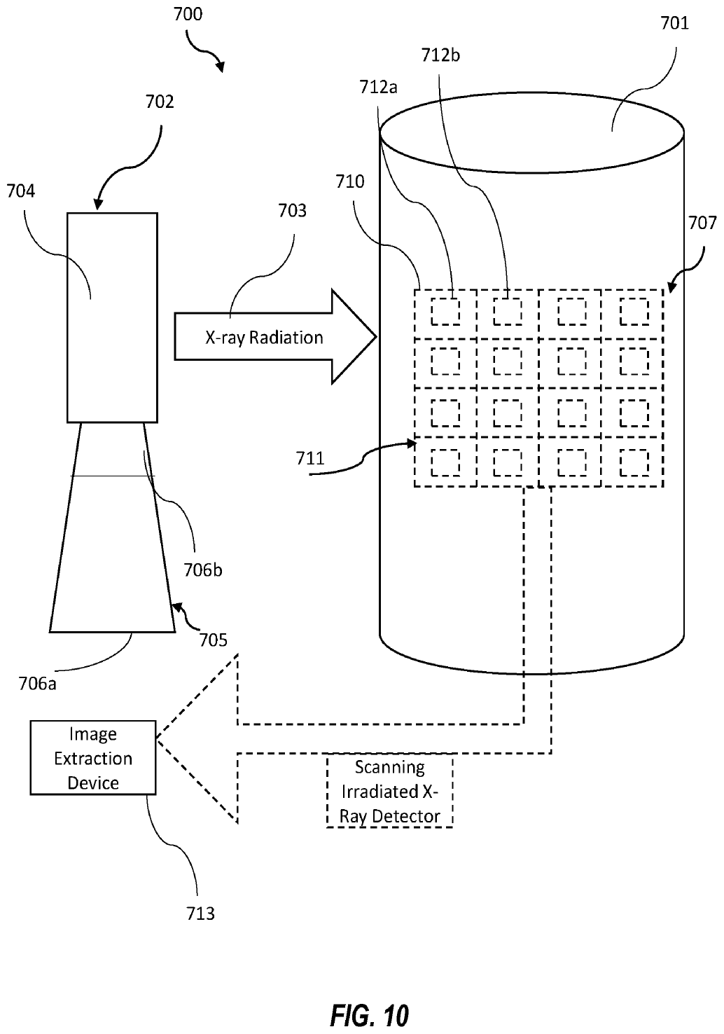

In other embodiments (FIG. 10), each X-ray sensing segment 112a-112n comprises an X-ray film segment. In these embodiments, the X-ray film segments are subsequently developed and digitally scanned for ingestion by the image extraction device 113.

Also, the X-ray detector 107 comprises a plurality of fasteners carried by the carrier layer 110 and for fixing the carrier layer to the object 101. For example, each fastener may comprise an adhesive strip layer, or a mechanical coupling, such as a spring loaded clamp.

In a typical application where the object 101 comprises a cast resin transformer, the process for imaging and inspecting the cast resin transformer is as follows. The cast resin transformer may be depowered for this process, but may remain installed. The X-ray detector 107 is then inserted into the cast resin transformer. More specifically, the X-ray detector 107 is inserted between the resin tubular wall and the internal electronics, and the fastener is coupled to the resin tubular wall. Once the X-ray detector 107 is positioned, the X-ray source device 102 is positioned to irradiate the cast resin transformer. The image extraction device 113 is configured to receive a plurality of images from the plurality of X-ray sensing segments 112a-112n, and subsequently assemble the plurality of images into an image of the cast resin transformer.

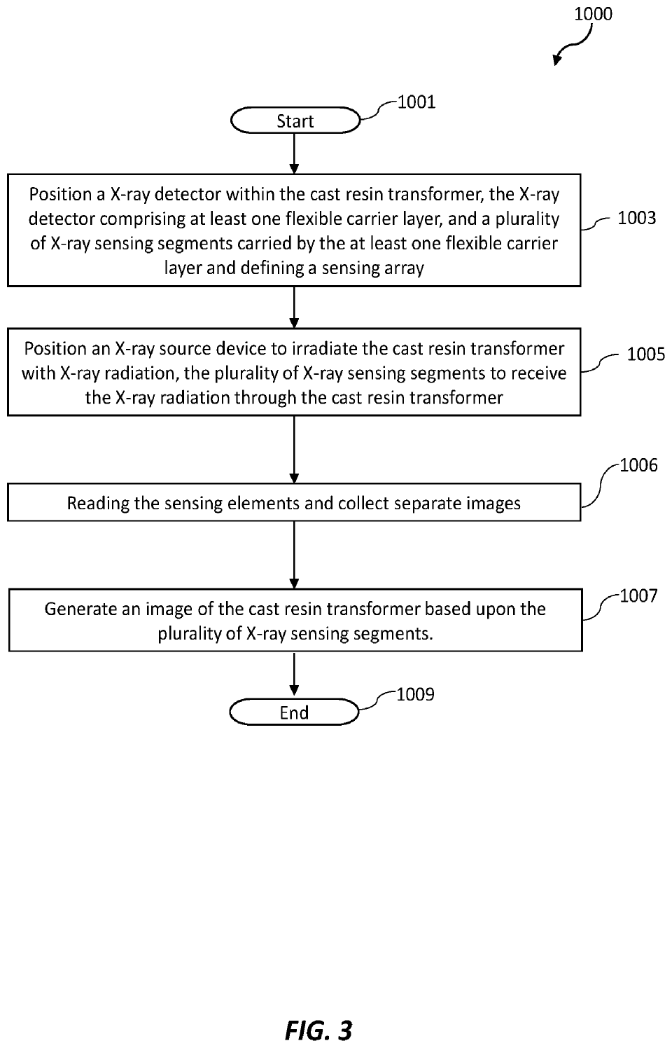

Referring now additionally to FIG. 3, generally, a method for X-ray radiation imaging of a cast resin transformer 101 is now described with a flowchart 1000. (Block 1001). The method includes positioning an X-ray detector 107 within the cast resin transformer 101. (Block 1003). The X-ray detector 107 comprises at least one carrier layer 110, and a plurality of X-ray sensing segments 112a-112n carried by the at least one carrier layer and defining a sensing array 111. The method includes positioning an X-ray source device 102 to irradiate the cast resin transformer 101 with X-ray radiation 103. (Block 1005). The plurality of X-ray sensing segments 112a-112n is to receive the X-ray radiation 103 from the cast resin transformer 101. The method comprises reading the plurality of X-ray sensing segments 112a-112n and collecting separate images from each sensing segment. (Block 1006). The method further comprises generating an image of the cast resin transformer 101 based upon the plurality of X-ray sensing segments 112a-112n. (Blocks 1007, 1009).

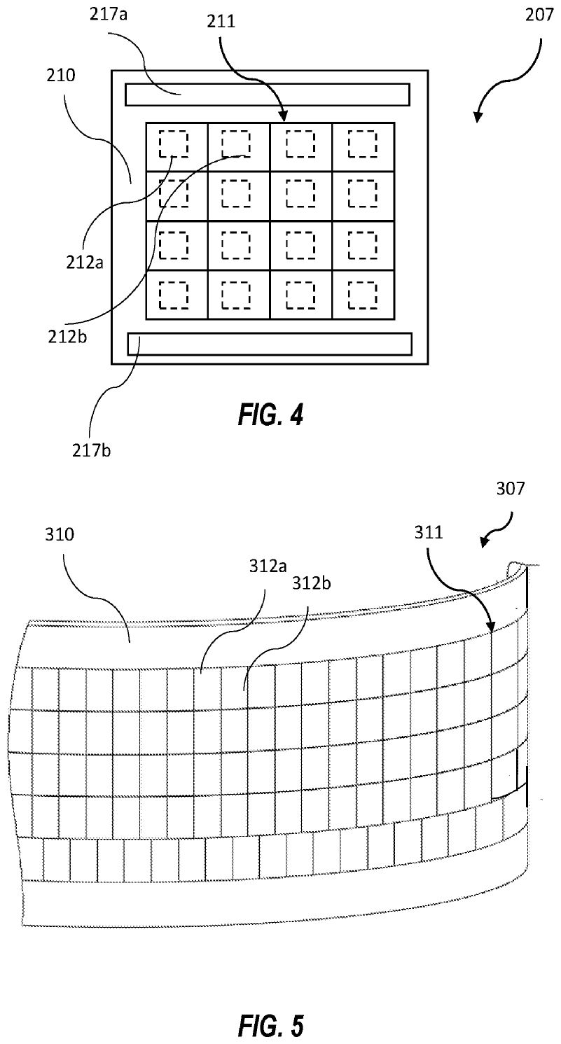

Referring now additionally to FIG. 4, another embodiment of the X-ray detector 207 is now described. In this embodiment of the X-ray detector 207, those elements already discussed above with respect to FIGS. 1-3 are incremented by 100 and most require no further discussion herein. This embodiment differs from the previous embodiment in that this X-ray detector 207 includes a carrier layer 210, and a plurality of X-ray sensing segments 212a-212n carried by the carrier layer and defining a sensing array 211. Here, the X-ray detector 207 illustratively includes first and second fastener strips 217a-217b carried by the carrier layer 210 respectively at first and second opposing sides of the carrier layer.

In some embodiments, the first and second fastener strips 217a-217b each comprises an adhesive layer for coupling to the object. In other embodiments, the first and second fastener strips 217a-217b comprises hook and loop fasteners, or other mechanical fasteners (e.g. spring loaded clamp).

Referring now additionally to FIG. 5, another embodiment of the X-ray detector 307 is now described. In this embodiment of the X-ray detector 307, those elements already discussed above with respect to FIGS. 1-3 are incremented by 200 and most require no further discussion herein. This embodiment differs from the previous embodiment in that this X-ray detector 307 includes a flexible carrier layer 310, and a sensing array 311 carried by the flexible carrier layer. Here, the flexible carrier layer 310 is in a non-planar shape, for example, the illustrated curved surface. As will be appreciated, this enables the X-ray detector 307 to be readily inserted into the arcuate space of a cast resin transformer.

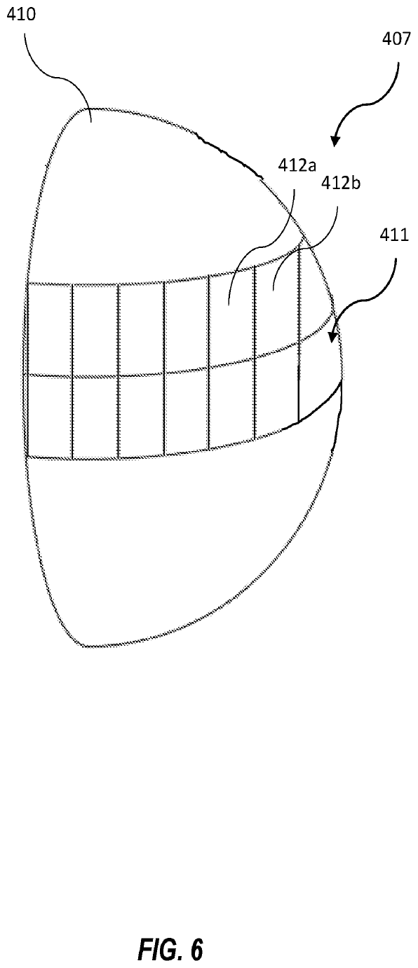

Referring now additionally to FIG. 6, another embodiment of the X-ray detector 407 is now described. In this embodiment of the X-ray detector 407, those elements already discussed above with respect to FIGS. 1-3 are incremented by 300 and most require no further discussion herein. This embodiment differs from the previous embodiment in that this X-ray detector 407 includes a flexible carrier layer 410, and a sensing array 411 carried by the flexible carrier layer. Here, the flexible carrier layer 410 is in a non-planar shape, for example, the sphere-shaped surface.

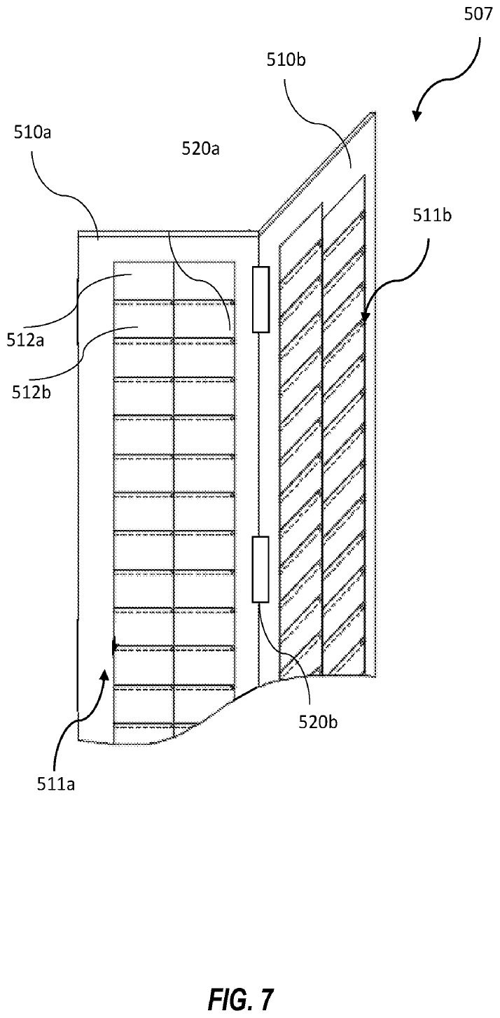

Referring now additionally to FIG. 7, another embodiment of the X-ray detector 507 is now described. In this embodiment of the X-ray detector 507, those elements already discussed above with respect to FIGS. 1-3 are incremented by 400 and most require no further discussion herein. This embodiment differs from the previous embodiment in that this X-ray detector 507 includes a plurality of carrier layers 510a-510b, and a plurality of fasteners 520a-520b coupling the plurality of carrier layers together. In the illustrated embodiment, the plurality of carrier layers 510a-510b is arranged in a three-dimensional shape, for example, the illustrated L-shaped box.

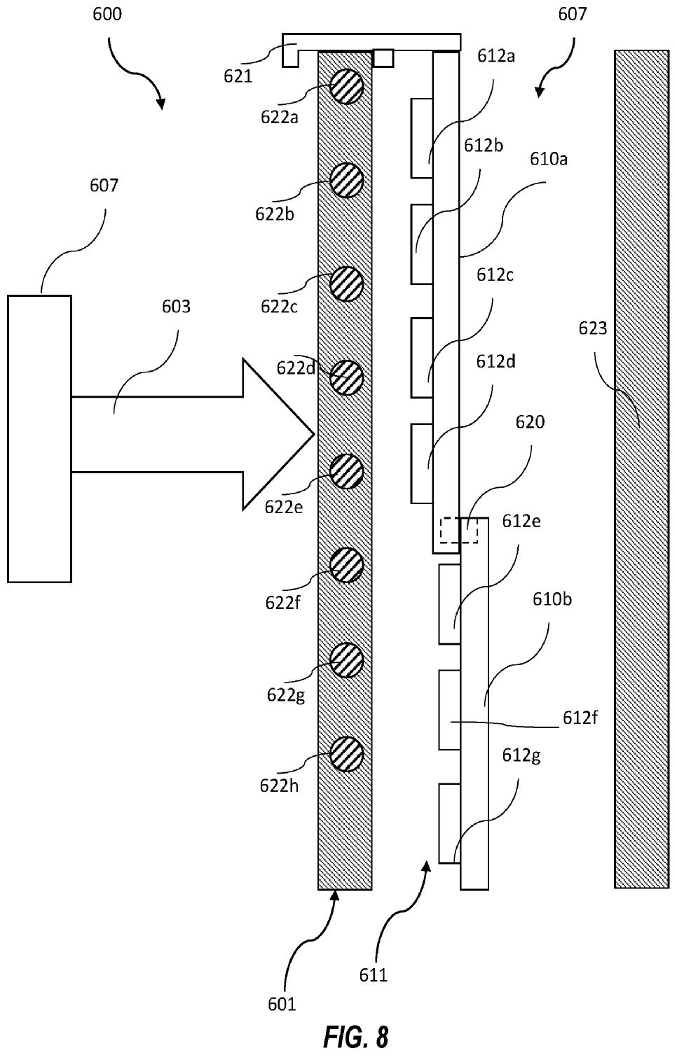

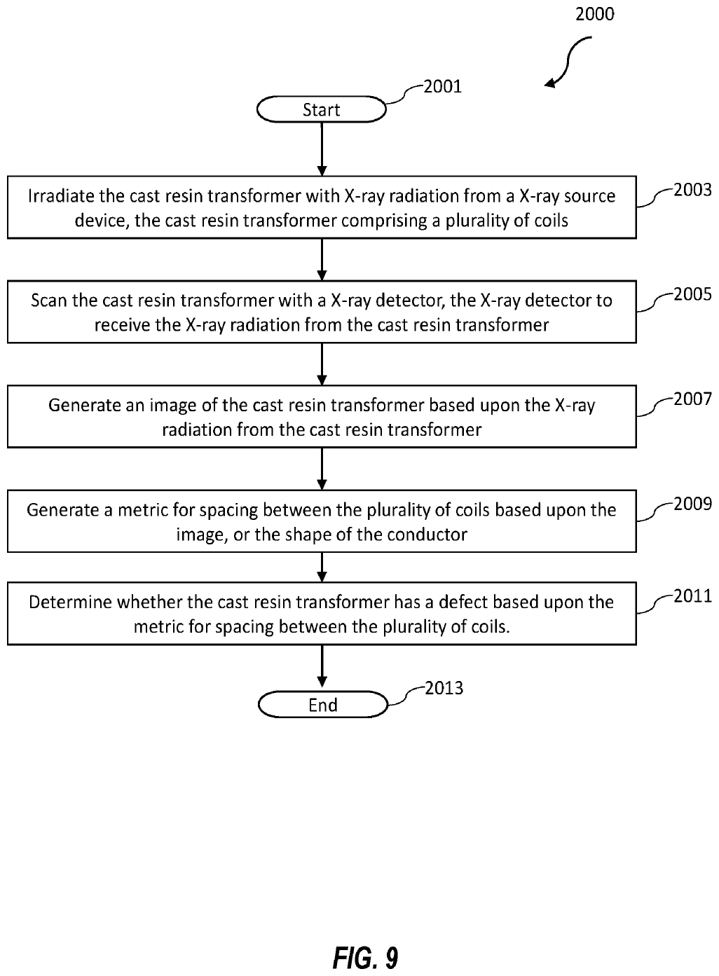

Referring now additionally to FIG. 8, another embodiment of the X-ray detector 607 is now described. In this embodiment of the X-ray detector 607, those elements already discussed above with respect to FIGS. 1-3 are incremented by 500 and most require no further discussion herein. This embodiment differs from the previous embodiment in that this X-ray detector 607 includes an upper carrier layer 610a, a lower carrier layer 610b, and a fastener 620 coupling the upper and lower flexible layers.

This X-ray detector 607 illustratively comprises an arm 621 coupled to an upper carrier layer 610a, and the arm extends transverse to the upper carrier layer and to engage (i.e. clamping an uppermost end) the cast resin transformer 601. The cast resin transformer 601 illustratively includes a plurality of coils 622a-622h. For example, the arm 621 illustratively includes a clamp device.

Here, advantageously, the X-ray detector 607 has a slim side profile, which allows for insertion between the outer tubular body of the cast resin transformer 601 and inner electronics 623. This permits for the cast resin transformer 601 to be scanned while still installed within an application.

Referring now to FIGS. 8 & 9, a method for detecting a defect in a cast resin transformer 601 is now described with a flowchart 2000. (Block 2001). The method includes irradiating the cast resin transformer 601 with X-ray radiation 603 from an X-ray source device 602. (Block 2003). The cast resin transformer 601 comprises a plurality of coils 622a-622h. The method comprises scanning the cast resin transformer 601 with an X-ray detector 607. (Block 2005). The X-ray detector 607 is to receive the X-ray radiation 603 from the cast resin transformer 601. The method comprises generating an image of the cast resin transformer 601 based upon the X-ray radiation 603 from the cast resin transformer. (Block 2007).

Moreover, the method comprises generating a metric for spacing between the plurality of coils 622a-622h based upon the image or based upon the shape of conductor in the coil. (Block 2009). The generating of the metric comprises generating a plurality of spacing values for the plurality of coils 622a-622h of the cast resin transformer 601, and determining a distribution of the plurality of spacing values. In some embodiments, the generating of the plurality of spacing values for the plurality of coils 622a-622h of the cast resin transformer 601 may comprise edge detection processing. The method may also include analyzing the shape of the plurality of coils 622a-622h. In particular, the shape features may comprise straightness value and being free of burrs or spikes on the conductor.

The method further comprises determining whether the cast resin transformer 101 has a defect based upon the metric for spacing between the plurality of coils 622a-622h. (Blocks 2011, 2013). In particular, the metric for spacing between the plurality of coils 622a-622h is based upon the distribution of values. In this instance, the metric represents the percentage of coils outside first or second standard deviation of the distribution. In short, the metric flags spacing outliers, which would be indicative of a manufacturing defect.

Referring now additionally to FIG. 10, another embodiment of the X-ray radiation imaging system 700 is now described. In this embodiment of the X-ray radiation imaging system 700, those elements already discussed above with respect to FIGS. 1-3 are incremented by 600 and most require no further discussion herein. This embodiment differs from the previous embodiment in that this X-ray radiation imaging system 700 includes an image extraction device 713 configured to ingest the X-ray detector 707. In particular, the image extraction device 713 is configured to determine an exposed state of each of the plurality of X-ray sensing segments 712a-712n and stitch together an image of the object 701. For example, the image extraction device 713 may comprise a scanner device to scan the plurality of X-ray sensing segments 712a-712n for their respective image segments. Of course, this embodiment of the X-ray radiation imaging system 700 provides more of manual approach as compared to the embodiments of FIGS. 1-3.

Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

1. An X-ray radiation imaging system for imaging an object, the X-ray radiation imaging system comprising:
an X-ray source device configured to irradiate the object with X-ray radiation;
an X-ray detector to be positioned adjacent the object and comprising
at least one carrier layer, and
a plurality of X-ray sensing segments carried by the at least one carrier layer and defining a sensing array, the plurality of X-ray sensing segments to receive the X-ray radiation through the object; and
an image extraction device configured to generate an image of the object based upon the X-ray detector.

2. The X-ray radiation imaging system of claim 1 wherein the sensing array comprises a rectangle-shaped array.

3. The X-ray radiation imaging system of claim 1 wherein each X-ray sensing segment comprises an X-ray phosphor plate.

4. The X-ray radiation imaging system of claim 1 wherein each X-ray sensing segment in the sensing array comprises an identifier opaque to the X-ray radiation through the object; and wherein the image extraction device is configured to generate the image of the object based upon a known position of respective identifiers in the sensing array.

5. The X-ray radiation imaging system of claim 1 wherein the X-ray detector comprises an arm coupled to the at least one carrier layer, the arm extending transverse to the at least one carrier layer and to engage the object.

6. The X-ray radiation imaging system of claim 5 wherein the arm comprises a clamp device.

7. The X-ray radiation imaging system of claim 1 wherein the at least one carrier layer comprises a plurality of carrier layers, and a plurality of fasteners coupling the plurality of carrier layers together.

8. The X-ray radiation imaging system of claim 7 wherein the plurality of carrier layers is arranged in a three-dimensional shape.

9. The X-ray radiation imaging system of claim 1 wherein the X-ray source device comprises an X-ray source, and a platform carrying the X-ray source; and wherein the platform is configured to position the X-ray source to irradiate the object based upon the sensing array.

10. An X-ray radiation imaging system for imaging a cast resin transformer, the X-ray radiation imaging system comprising:
an X-ray source device configured to irradiate the cast resin transformer with X-ray radiation;
an X-ray detector to be positioned within the cast resin transformer and comprising
at least one curved flexible carrier layer to be coupled to the cast resin transformer, and
a plurality of X-ray sensing segments carried by the at least one curved flexible carrier layer and defining sensing array, the plurality of X-ray sensing segments to receive the X-ray radiation through the cast resin transformer; and
an image extraction device configured to generate an image of the cast resin transformer based upon the X-ray detector.

11. The X-ray radiation imaging system of claim 10 wherein the sensing array comprises a rectangle-shaped array.

12. The X-ray radiation imaging system of claim 10 wherein each X-ray sensing segment comprises an X-ray phosphor plate.

13. The X-ray radiation imaging system of claim 10 wherein each X-ray sensing segment in the sensing array comprises an identifier opaque to the X-ray radiation through the cast resin transformer; and wherein the image extraction device is configured to generate the image of the cast resin transformer based upon a known position of respective identifiers in the sensing array.

14. The X-ray radiation imaging system of claim 10 wherein the X-ray detector comprises an arm coupled to the at least one curved flexible carrier layer, the arm extending transverse to the at least one curved flexible carrier layer and to engage the cast resin transformer.

15. The X-ray radiation imaging system of claim 14 wherein the arm comprises a clamp device.

16. The X-ray radiation imaging system of claim 10 wherein the at least one curved flexible carrier layer comprises a plurality of curved flexible carrier layers, and a plurality of fasteners coupling the plurality of curved flexible carrier layers together.

17. A method for X-ray radiation imaging of a cast resin transformer, the method comprising:
positioning an X-ray detector within the cast resin transformer, the X-ray detector comprising
at least one carrier layer, and
a plurality of X-ray sensing segments carried by the at least one carrier layer and defining a sensing array;
positioning an X-ray source device to irradiate the cast resin transformer with X-ray radiation, the plurality of X-ray sensing segments to receive the X-ray radiation through the cast resin transformer; and
generating an image of the cast resin transformer based upon the plurality of X-ray sensing segments.

18. The method of claim 17 wherein the sensing array comprises a rectangle-shaped array.

19. The method of claim 17 wherein each X-ray sensing segment comprises an X-ray phosphor plate.

20. The method of claim 17 wherein each X-ray sensing segment in the sensing array comprises an identifier opaque to the X-ray radiation through the cast resin transformer; and further comprising generating the image of the cast resin transformer based upon a known position of respective identifiers in the sensing array.

21. The method of claim 17 wherein the X-ray detector comprises an arm coupled to the at least one carrier layer, the arm extending transverse to the at least one carrier layer and to engage the cast resin transformer.

22. A method for detecting a defect in a cast resin transformer, the method comprising:
irradiating the cast resin transformer with X-ray radiation from an X-ray source device, the cast resin transformer comprising a plurality of coils;
scanning the cast resin transformer with an X-ray detector comprising at least one carrier layer, and a plurality of X-ray sensing segments carried by the at least one carrier layer and defining a sensing array, the plurality of X-ray sensing segments to receive the X-ray radiation through the cast resin transformer;
generating an image of the cast resin transformer based upon the X-ray radiation through the cast resin transformer and using separate individual images from each X-ray sensing segment;
generating a metric for spacing between the plurality of coils based upon the image; and
determining whether the cast resin transformer has a defect based upon the metric for spacing between the plurality of coils.

23. The method of claim 22 wherein the generating of the metric comprises:
generating a plurality of spacing values for the plurality of coils of the cast resin transformer; and
determining a distribution of the plurality of spacing values.

24. The method of claim 23 wherein the generating of the plurality of spacing values for the plurality of coils of the cast resin transformer comprises edge detection processing.
